(19) United States
(12) Patent Application Publication
(10) Pub. No.: US 2005/0193975 A1
(43) Pub. Date: Sep. 8, 2005

(54) Rotary engine

(76) Inventor: Dong Hyun Kim, Degu (KR)

Correspondence Address: Richard J. Streit;Ladas & Parry LLP, Suite 1200, 224 South Michigan Avenue, Chicago, IL, 60604, US

(21) Appl. No.: 11/063,656

(22) Filed: Feb. 23, 2005

(30) Foreign Application Priority Data
Mar. 5, 2004 (KR) 20-2004-0006078

(51) Int. Cl. F02B 57/00; F02B 53/00

(52) U.S. Cl. 123/241; 123/43 R; 91/491

(57) ABSTRACT

The present invention relates to a rotary engine in which gas supplied through a housing and a rotary shaft is guided to flow only through a suction path of the rotary shaft. The movement of the opening and closing plate is decreased with respect to one rotation of the rotary shaft. A suction opening and closing valve is designed to have an increased suction amount. A locking rod locks and unlocks the piston so that a tail part of the piston does not press a guide member based on a gas explosion in the interior of a combustion chamber. The bent portion of the path formed in the tail part of the opening and closing plate is smoothened by a gas path formed by a path support plate. The path support plate that stores gas heat decreases non-combustion gas. Pitches formed between an external surface of the rotary assembly and an inner wall of the housing due to the supply of lubricant is removed by a cooling member installed at a wall surface between an upper plate and a lower plate of the housing and a scratching seal.

### BACKGROUND OF THE INVENTION

1. Field of the Invention

The present invention relates to a rotary engine.

2. Description of the Background Art

As a related known art of the present invention, there are rotary engines (patent numbers: 2003-0058930, 20-0332314, and 20-2003-0025777), a piston guide apparatus of a rotary engine (0227567), and a rotary piston and a seal (patent number: 2003-0022751) filed by the applicant of the present invention.

In the above rotary engine, a suction path 6-1 is constructed at a rotary shaft 6, and an exhaust chamber 30 is constructed at a housing 2. An opening and closing guide path 4-5 along which an opening and closing plate guide rod 18-5 moves is bent one time as compared to the conventional art in which it is bent two times. A suction valve is exchanged with a suction opening and closing valve 22. An explosion gas presses a piston 12. In an improved piston locking apparatus, a friction that a tail part 12-3 provides to a guide member 40 is decreased. The flow of an exhaust gas of the tail part 26-2 of an opening and closing plate 26-3 is enhanced. Non-combusted gas is decreased. Lubricant is efficiently supplied between a rotary assembly 8 and the housing 2 for thereby decreasing smoke and enhancing heat efficiency and a high revolution and performance in a rotary engine.

According to a related known art of the applicant of the present invention (PCT/KOR03/01899), an exhaust part 32 and a suction part are installed at a housing 2. The distance between the same is short. Therefore, when the rotary assembly 8 is rotated one time, the tail part 26-2 of the opening and closing plate 26 reciprocates two times, so that over load is applied thereto. A certain apparatus adapted to prevent a rear side 12-5 of the piston 12 from being pressed by an explosion pressure after a compression cycle is performed and to prevent the tail part 12-3 from getting friction with the guide member 40. The bent area of a spraying path formed by the tail part 26-2 of the opening and closing plate 26-3 is large, and the discharge of the non-combustion gas of an operation chamber 10 and the combustion chamber 10-1 is prevented, and the flow of the lubricant between the rotary assembly 8 and the housing 2 is not efficient.

### SUMMARY OF THE INVENTION

Accordingly, it is an object of the present invention to provide a rotary engine capable of overcoming the problems encountered in the conventional art.

It is another object of the present invention to provide a rotary engine in which gas supplied through a housing and a rotary shaft is guided to flow only through a suction path of the rotary shaft. The movement of the opening and closing plate is decreased with respect to one rotation of the rotary shaft. A suction opening and closing valve is designed to have an increased suction amount. A locking rod locks and unlocks the piston so that a tail part of the piston does not press a guide member based on a gas explosion in the interior of a combustion chamber. The bent portion of the path formed in the tail part of the opening and closing plate is smoothened by a gas path formed by a path support plate. The path support plate that stores gas heat decreases non-combustion gas. Pitches formed between an external surface of the rotary assembly and an inner wall of the housing due to the supply of lubricant is removed by a cooling member installed at a wall surface between an upper plate and a lower plate of the housing and a scratching seal.

To achieve the above objects, in a rotary engine in which in a housing, an upper plate and a lower plate are engaged to a cylindrical body pipe having an exhaust port, and guide paths are formed at opposite inner surfaces of the upper plate and the lower plate, and an elliptical guide member is integrally protruded from an inner center portion of the lower plate, and a rotary shaft having a suction path, a supply path and an exhaust path passes through the centers of the upper plate and the lower plate having the guide member of the housing, and the rotary assembly is integrally engaged with the rotary shaft using the upper plate and is positioned between the upper plate and the lower plate in the cylindrical housing, and at least one operation chamber is provided in the rotary assembly, and a piston having a piston shaft pin at one side in the operation chamber passes through the guide member in the operation chamber, and the front surface and the tail part of the piston contact with an outer surface of the elliptical guide member, and when the rotary assembly is rotated, the piston guide rod is moved along the piston guide path, and the piston is moved with respect to the piston shaft pin using a piston guide rod as a lever for thereby performing a compression stroke, and the front surface and the tail part of the piston contact with an outer surface of the elliptical guide member for thereby performing a compression stroke in a rotary engine, there is provided an improved rotary engine that is characterized in that a locking guide rod of a rotary assembly is moved along a locking guide path of the inner surfaces of the upper plate and the lower plate of the housing in order to fix the piston after the compression stroke is performed, and the locking rod is moved using the locking guide rod as a lever and the locking rod shaft pin as an axis for thereby catching and locking the tail part shoulder of the piston, and when gas is exploded in the combustion chamber by an ignition apparatus of the combustion chamber, the opening and closing plate guide rod of the rotary assembly moving along the opening and closing guide path is moved, and the opening and closing plate having a gas path adapted to enhance a gas flow is opened in the exhaust chamber sectioned by an exhaust chamber seal using the opening and closing plate guide rod as a lever and the opening and closing plate shaft pin as an axis, and the exhaust guide rod of the rotary assembly moving along the exhaust valve guide path opens the exhaust valve using the exhaust guide rod as a lever and the exhaust valve shaft pin as an axis, so that the gas is expanded from the combustion chamber to the exhaust chamber for thereby rotating the rotary assembly, and when the gas is discharged through the exhaust port, the locking guide rod of the rotary assembly is moved along the locking guide path, and the locking rod is moved in order to unlock the tail part shoulder of the piston using the locking guide rod as a lever and the locking rod shaft pin as an axis, and the suction guide rod is moved along the suction valve guide path, and the gas is sucked into the operation chamber using the suction guide rod as a lever and the suction opening and closing valve shaft pin as an axis, and the suction opening and closing plate of the suction path is moved and opened for thereby achieving a suction stroke of the piston, and a cooling member is formed in such a manner that part of lubricant supplied from the supply path of the rotary shaft 6 flows from the upper side of the inner wall surface of the housing to the lower side, and a scratching seal is attached for thereby preventing a generation of pitches at an outer surface of the rotary assembly, and the lubricant is moved in the direction of the discharge path.

### BRIEF DESCRIPTION OF THE DRAWINGS

The present invention will become better understood with reference to the accompanying drawings which are given only by way of illustration and thus are not limitative of the present invention, wherein;

FIG. 1 is a vertical cross sectional view taken along line A-A of FIG. 2 illustrating a rotary engine according to the present invention;

FIG. 2 is a plane cross sectional view illustrating a rotary engine according to the present invention;

FIG. 3 is a plane cross sectional view illustrating a rotary engine of which piston is rotated in a reverse direction according to the present invention;

FIG. 4 is a perspective view illustrating a rotary assembly wherein a housing exhaust chamber seal is shown according to the present invention;

FIG. 5 is a view illustrating the construction of a suction opening and closing valve according to the present invention;

FIG. 6 is a view illustrating the construction of an exhaust valve according to the present invention;

FIG. 7 is a view illustrating the construction of a piston locking apparatus according to the present invention;

FIG. 8 is a view illustrating the construction of a lubricant supply block according to the present invention;

FIG. 9 is a view illustrating the construction of a piston guide rod, a suction guide rod and a locking guide rod according to the present invention; and

FIG. 10 is a view illustrating the construction of a guide path of an exhaust guide rod and an opening and closing plate guide rod according to the present invention.

### DETAILED DESCRIPTION OF THE PREFERRED EMBODIMENTS

In the present invention, an electric ignition by a plug and a spraying ignition by an injector are referred to an ignition apparatus 46, and an electric code or a fuel supply pipe is referred to a supply line 44, and air or mixed gas is referred to a gas. Here, the gas is supplied to an operation chamber 10 and a combustion chamber 10-1 through the rotary shaft 6, and fuel or electric power is supplied to the combustion chamber 10-1 through the rotary shaft 6. A fuel supply pump or a power supply panel is implemented using the rotary shaft 6.

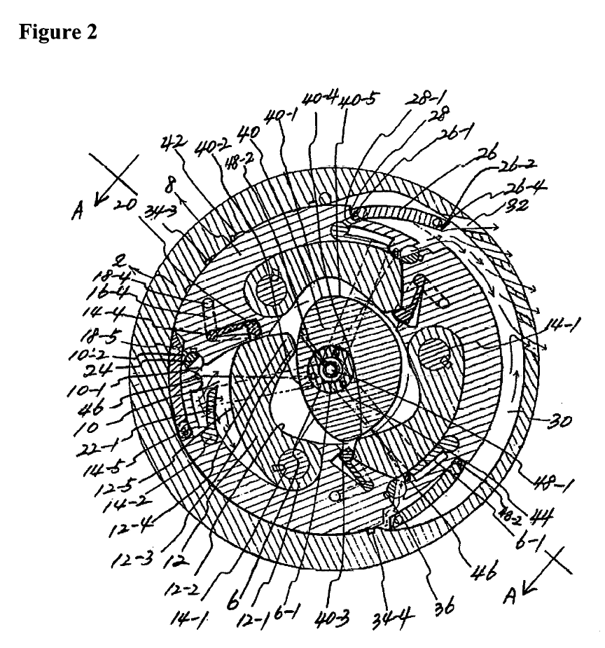

As shown in FIG. 2, in the rotary engine according to the present invention, a head part 12-1, a front part 12-2 and a tail part 12-3 of a piston 12 in an operation chamber 10 of a rotary shaft 8 are rotation-contacted with an elliptical outer surface of a guide member 40 of a housing 2, and the tail part 12-3 of the piston 12 reciprocates up and down in the direction of the operation chamber 10 with respect to a piston shaft pin 14-1 in which the head part 12-1 is positioned, so that a suction stroke and a compression stroke are performed. In addition, in the suction stroke, a lead part 12-3 of the piston 12 is moved from a top dead center 40-1 to a bottom dead center 40-2 for thereby achieving a forced suction operation. Thereafter, a compression stroke is performed. When the gas in the combustion chamber 10-1 is exploded by the ignition apparatus 46, the exhaust valve 24 is opened, and the expansion gas pushes the rear side of the opening and closing plate 26-3 of the pieces that section the exhaust chamber 30 for thereby rotating the rotary assembly 8, and the gas is exhausted through the exhaust port 32.

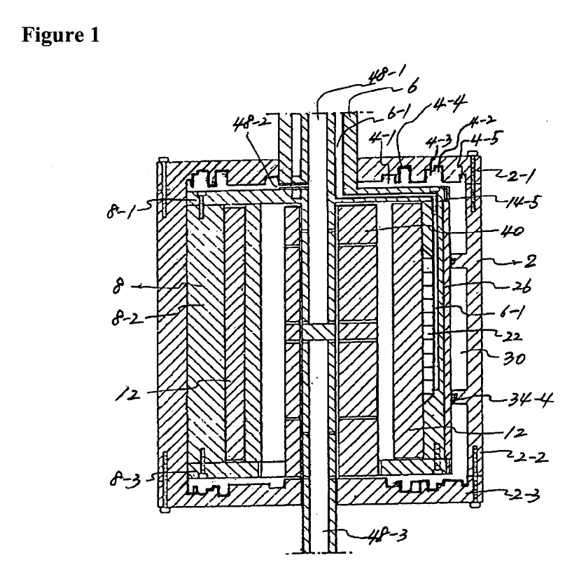

As shown in FIGS. 1 and 2, the housing 2 is formed in a can shape. An elliptical guide member 40 is positioned at a center portion of a body pipe 2-2 and a lower plate 2-3 having a circular upper plate 2-1 and a rotary member 8 having a shaft hole for an insertion of the upper rotary shaft 6 at the center, and the shaft hole for an insertion of the rotary shaft 6 of the rotary assembly 8 passes through the guide member 40, and the above structure is fixed using bolts.

As shown in FIGS. 1, 9 and 10, there are provided a piston guide path 4-1, a suction valve guide path 4-2, an exhaust valve guide path 4-3, a locking rod guide path 4-4, and an opening and closing plate guide path 4-5 at the inner surface opposite to the upper plate 2-1 and the lower plate 2-3. The above structure is formed in a certain track shape.

As shown in FIG. 1, even when each guide path 4 is overlapped, in the construction that the guide rod 18 moves along the track, the thickness and length of each guide rod 18 are different. The width and depth at the same track of the inner surfaces of the upper plate 2-1 and the lower plate 203 are different.

As shown in FIG. 2, the elliptical shape of the guide member 40 protruded from the center of the lower plate 2-3 is connected through the top dead center 40-1, the bottom dead center 40-2, the top dead center 40-3, the take-off bottom dead center 40-4, and the landing bottom dead center 40-5.

As shown in FIGS. 1, 2 and 4, the exhaust chamber 30 is formed at the inner surface of the body pipe 2-2 in such a manner that the exhaust chamber seal 34-4 through which the opening and closing plate 26-3 passes is surrounded in all directions. In addition, there is a space similar with the exhaust chamber 30 in which the opening and closing plate guide rod 16-5 supporting the movement of the opening and closing plate 26-3 at certain distances between the same is operated. As shown in FIG. 2, there are provided a cooling member 42 through which lubricant flows at the wall surface between the upper plate 2-1 and the lower plate 2-3, and a scratching seal 34-3 formed in the shape of the lubricant supply block 36. Pitches formed between an outer surface of the rotary assembly 8 having the opening and closing plate 26 and an inner surface of the housing 2 are removed, and lubricant is cooled.

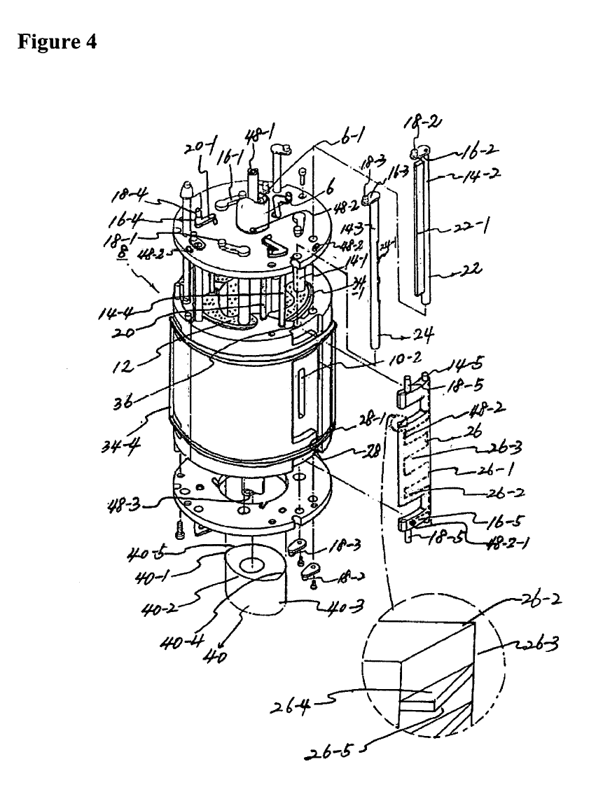

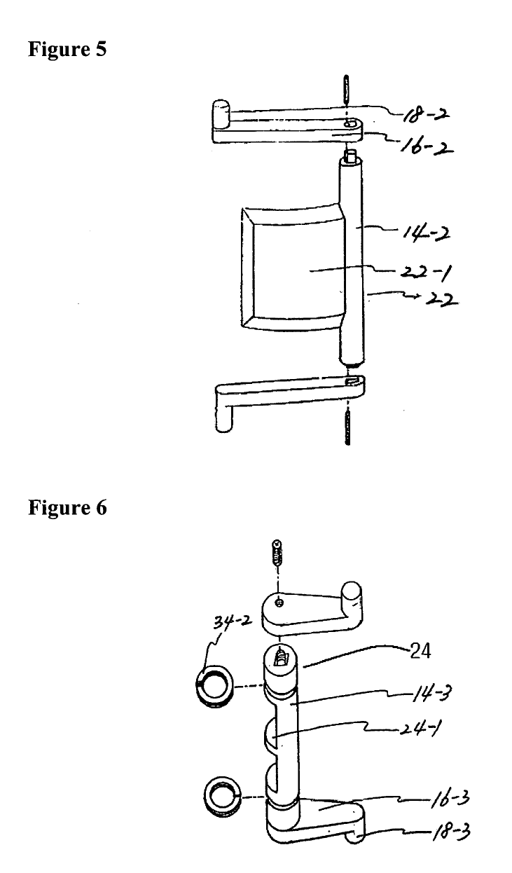

As shown in FIGS. 1 and 4, the rotary assembly 6 includes an upper plate 8-1 integrally formed with the rotary shaft 6, a donut shaped rotary body 8-2, and a lower plate 8-3. Gaskets are disposed therebetween, and the above structures are fixed using bolts.

As shown in FIGS. 1, 2 and 4, there are provided a flow path 48 and a suction path 6-1 at the rotary shaft 6 integral with the upper plate 8-1 for inputting and outputting lubricant. An electric power panel or compressor may be attached for supplying electric power or fuel. A supply line 44 is connected with the ignition apparatus 46 of the combustion chamber 10-1.

A turbine type compressor is installed at the rotary shaft 6 in the front and rear sides of the flow path 48 for the purposes of supply and discharge. A gas supply member is installed at the suction path 6-1.

As shown in FIGS. 2 and 4, in the rotary assembly 8, the suction opening and closing valve 22 opens and closes the operation chamber 10 having at least one combustion chamber 10-1 connected with the suction path 6-1 of the rotary shaft 6. The exhaust valve 24 opens and closes the portion between the combustion chamber 10-1 and the exhaust hole 10-2. The tail part 12-3 of the piston 12 having the piston seal 34-1 reciprocates up and down with respect to the piston shaft pin 14-1. Therefore, the suction stroke and compression stroke are performed based on the rear surface 12-5 in the operation chamber 10.

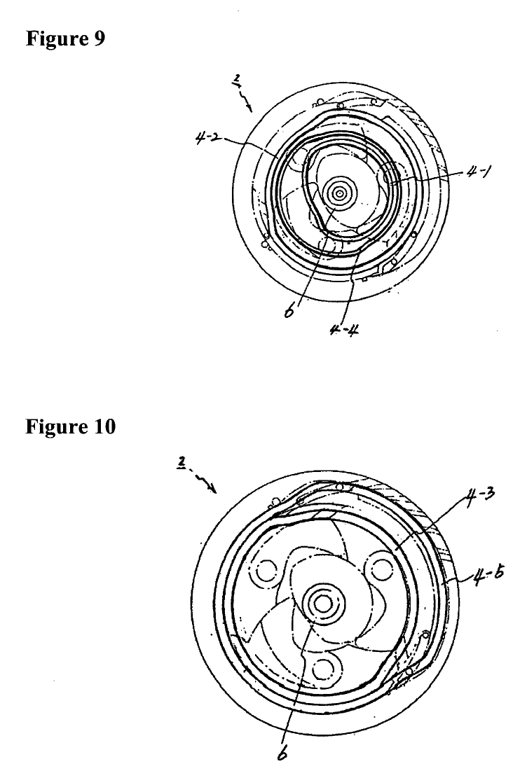

As shown in FIGS. 4 and 9, a piston guide rod 16-1 is installed vertically at both ends of the piston shaft pin 14-1 passing through the upper plate 8-1, the rotation body 8-2, and the lower plate 8-3. The piston guide rod 18-1 that is vertically integrally connected at the ends is track-moved along the piston guide path 4-1 formed at the upper plate 2-1 and the lower plate 2-3 of the housing 2 as the rotary assembly 8 is rotated, so that the piston 12 integrally engaged with the piston shaft pin 14-1 is moved, and the gas is forcibly sucked into the interior of the operation chamber 10. As shown in FIGS. 2, 4 and 9, in the suction opening and closing valve 22, a suction opening and closing plate 22-1 is installed at an intermediate portion of the suction opening and closing valve shaft pin 14-2 passing through the upper plate 8-1, the rotary body 8-2 and the lower plate 8-3, and the suction guide rod 16-2 is installed vertically at both ends. The suction guide rod 18-2 is vertically connected. The suction guide rod 18-2 is track-moved along the suction valve guide path 4-2 formed at the inner surfaces of the upper plate 2-1 and the lower plate 2-3 of the housing 2 as the rotary assembly 8 is rotated, so that the suction opening and closing valve 22 opens and closes the suction path 6-1.

As shown in FIGS. 2, 4, 6 and 10, in the exhaust valve 24, the exhaust valve shaft pin 14-3 passing through the upper plate 8-1 of the rotary assembly 8, the rotary assembly 8-2 and the lower plate 8-3 always contacts with the wall surface of the shaft hole formed at the main body wherein the shaft hole escape prevention plate 24-1 is integrally attached at the path of the intermediate portion of the exhaust valve shaft pin 14-3, and the exhaust guide rod 16-3 is formed vertically at both ends. The exhaust guide rod 18-3 is connected. The track movement is performed along the exhaust valve guide path 4-3 formed at the inner surfaces of the upper plate 2-1 and the lower plate 2-3 of the housing 2 based on the rotation of the rotary assembly 8, and the exhaust valve 24 opens and closes the exhaust hole 10-2.

Various valves may be adapted in such a manner that the exhaust valve 24 having the shaft hole escape prevention plate 24-1 may be adapted in the type of the suction opening and closing valve 22.

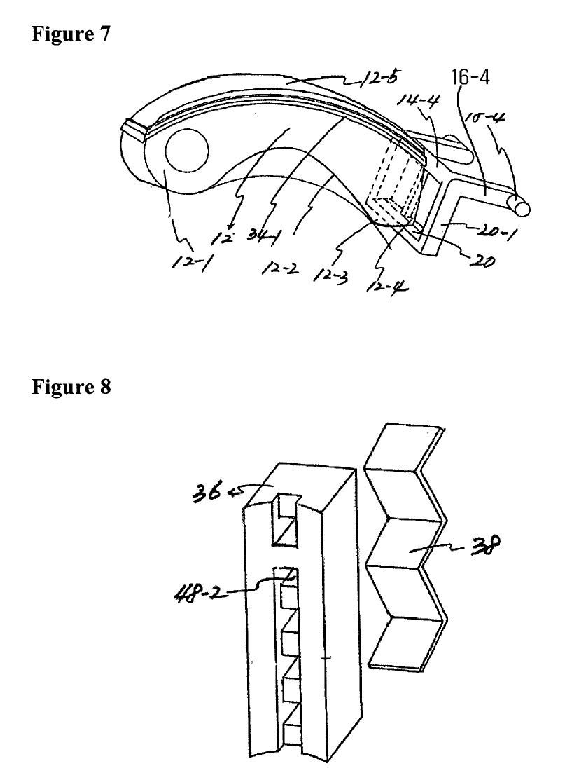

As shown in FIGS. 2 and 7, in the piston locking apparatus, the locking guide rod 16-4 and the locking guide rod 18-4 are integrally connected vertically at both ends of the locking rod shaft pin 14-4. When the rotary assembly 8 is rotated, the locking guide rod 18-4 is moved along the locking guide path 4-4. The locking connection rod 20-1 is connected vertically at both ends of the locking rod shaft pin 14-4. Both ends of the locking rod 20 are connected. When the tail part 12-3 of the piston 12 reaches at the top dead center 40-3, the locking rod 20 catches and locks the tail part shoulder 12-4 adapted to reinforce the supporting force, and the tail part 12-3 of the piston 12 takes off from the take-off bottom dead center 40-4 of the guide member 40, so that a certain gap is formed from the guide member 40. The gas exploded at the top dead center 40-3 is exhausted from the exhaust port 32, the tail part 12-3 of the piston 12 lands on the landing bottom dead center 40-5 of the guide member 40. When the tail part 12-3 reaches at the height of the top dead center 40-1, the locking rod 20 unlocks the tail part shoulder 12-4 of the piston 12.

As shown in FIGS. 2, 4 and 10, the opening and closing plate 26-3 is attached at an intermediate portion of the opening and closing plate shaft pin 14-5, and the opening and closing guide rod 16-5 is attached vertically at both ends. The opening and closing guide rod 18-5 is attached at an outer end portion of the opening and closing plate guide rod 16-5 in parallel with the opening and closing plate shaft pin 14-5. When the opening and closing plate guide rod 18-5 moves along the opening and closing plate guide path 4-5 formed at the inner surfaces of the upper plate 2-1 and the lower plate 2-3 of the housing 2 based on the rotation of the rotary assembly 8, the opening and closing plate 26-3 is opened and sectioned in the exhaust chamber 30 for thereby obtaining a certain performance. When it is escaped from the exhaust chamber 30, the same is closed.

The head part 26-1 protruded from the opening and closing plate shaft pin 14-5 is supported by the support surface 28-1 of the operation chamber 28 formed when the opening and closing plate 26 is opened and closed, so that the opening and closing plate 26 is opened at a limited angle. The tail part 26-2 does not have any friction with respect to the inner surface of the housing 2 in the exhaust chamber 30. As shown in FIG. 4, the path support plate 26-4 is formed near the tail part 26-2 that is the end of the opening and closing plate 26. When it is closed, the bottom is supported, and when it is opened, the gas path 26-5 is formed for thereby making the flow of the gas smooth and becoming the heat plate capable of storing exhaust heat, so that non-combustion gas is decreased.

When the opening and closing plate 26 is folded, the rotary assembly 8 forms a circular outer surface.

As shown in FIGS. 1, 2 and 4, the lubricant supplied from the supply flow path 48-1 of the rotary shaft 6 flows through the operation holes of the lubricant supply block 36 pressed by the spring 38 at the upper plate 8-1 of the rotary 8 through the supply fine path 48-2 and is supplied to the rotary shaft 6, the piston shaft pin 14-1, the piston seal 34-1 and the circumferential wall surfaces of each valve. The lubricant passed through the guide path 4 of the inner surface of the upper plate 2-1 of the housing 2 flows through at least one scratching seal 34-3 and the cooling member 42 formed at the wall surfaces of the housing 2 for thereby preventing pitches formed between the rotary assembly 8 and the wall surface of the housing 2. The exhaust chamber seal 34-4 installed at surrounding portions of the exhaust chamber 30 is sealed and lubricated and cooled. The lubricant supplied from the rotary shaft 6 to the guide member 40 is supplied to the outer surface and the front surface 12-2 and the tail part 12-3 of the piston 12 and is supplied to the interior and wall surface of the piston 12 and the piston seal 34-1 through the through holes passing through at certain horizontal and vertical heights in the direction from the piston seal 34-1 to the guide member 40 for preventing leakage and input of lubricant into the operation chamber 10. In the supply fine path 48-2 adapted for the cooling of the opening and closing plate 26, the lubricant passes from the head part 16-5 of the upper plate 8-1 of the rotary assembly 8 to the interior of the opening and closing plate 26-3 and is exhausted to the head part 26-1 of the lower plate 8-3 and the discharge hole 48-2-1 of the opening and closing plate guide rod 16-5 and is gathered at the guide path 4 of the inner surface of the lower plate 2-3 and is flown in the direction of the exhaust path 48-3 of the lower side of the rotary shaft 6. The supply path 48-1 passes through the upper plate 2-1 of the housing 2, and the exhaust path 48-3 passes through the lower plate 2-3 of the housing 2.

The lubricant supply block 36 installed at a semi-circular valve that is the exhaust valve 24 is installed in the direction that the semi-circular valve is rotated.

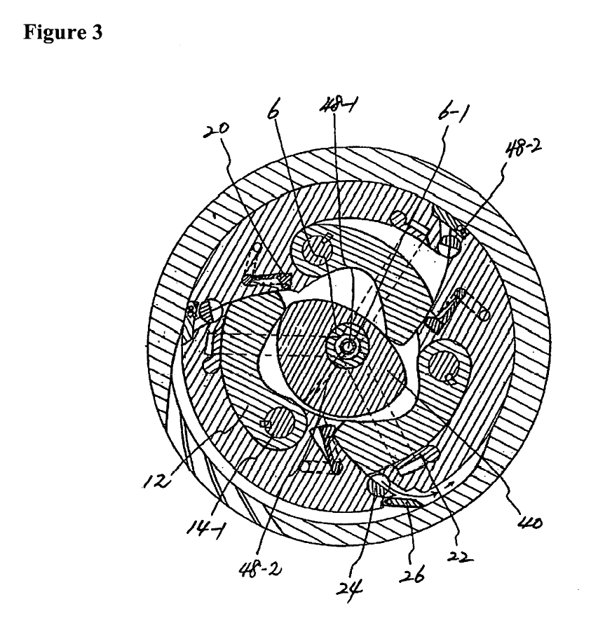

In the rotary shaft 6 or the shaft pin 14, a sealing groove is formed at the rotary shaft 6 or the shaft pin 14 so that lubricant does not leak. At least one sealing 34-2 is inserted and is designed to closely contact with the shaft hole for thereby preventing leakage of lubricant. As shown in FIG. 3, in the rotation of the rotary assembly 8, the rotation method is changed from the rotation method in which the rotation is performed over the head part 12-1 of the piston 12 to the rotation method in which the rotation is performed over the tail part 12-3 of the piston 12. The exhaust direction of the explosion gas and the direction of the combustion chamber 10-1 are changed, and the position of the head part 26-1 of the opening and closing plate 26 is changed.

As described above, when a desired suction is achieved based on the rotary assembly 8, and the bent portion of the opening and closing guide path 4-5 is decreased, and the piston 12 compresses the gas in the combustion chamber 10-1, and the tail part 12-3 prevents the pressure from being applied to the guide member 40, and the path support plate 26-4 of the opening and closing plate 26-3 forms a proper gas path for thereby enabling second combustion. Gas is supplied to the exhaust chamber 30 sectioned by the opening and closing plate 26 for thereby achieving a proper rotational force, and the gas is exhausted through the exhaust port 32, so that the lubricant is supplied to each necessary part of the engine for thereby decreasing smoke and achieving a high performance rotary engine.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In a rotary engine in which in a housing 2, an upper plate 2-1 and a lower plate 2-3 are engaged to a cylindrical body pipe 2-2 having an exhaust port 32, and guide paths 4-1, 4-2, 4-3, 4-4 and 4-5 are formed at opposite inner surfaces of the upper plate 2-1 and the lower plate 2-3, and an elliptical guide member 40 is integrally protruded from an inner center portion of the lower plate 2-3, and a rotary shaft 6 having a suction path 6-1, a supply path 48-1 and an exhaust path 48-3 passes through the centers of the upper plate 2-1 and the lower plate 2-3 having the guide member 40 of the housing 2, and the rotary assembly 8 is integrally engaged with the rotary shaft 6 using the upper plate 8-1 and is positioned between the upper plate 2-1 and the lower plate 2-3 in the cylindrical housing 2, and at least one operation chamber 10 is provided in the rotary assembly 8, and a piston 12 having a piston shaft pin 14-1 at one side in the operation chamber 10 passes through the guide member 40 in the operation chamber 10, and the front surface 12-2 and the tail part 12-3 of the piston 12 contact with an outer surface of the elliptical guide member 40, and when the rotary assembly 8 is rotated, the piston guide rod 18-1 is moved along the piston guide path 4-1, and the piston 12 is moved with respect to the piston shaft pin 14-1 using a piston guide rod 16-1 as a lever for thereby performing a compression stroke, and the front surface 12-2 and the tail part 12-3 of the piston 12 contact with an outer surface of the elliptical guide member 40 for thereby performing a compression stroke in a rotary engine, an improved rotary engine that is characterized in that a locking guide rod 18-4 of a rotary assembly 8 is moved along a locking guide path 4-4 of the inner surfaces of the upper plate 2-1 and the lower plate 2-3 of the housing 2 in order to fix the piston 12 after the compression stroke is performed, and the locking rod 20 is moved using the locking guide rod 16-4 as a lever and the locking rod shaft pin 14-4 as an axis for thereby catching and locking the tail part shoulder 12-4 of the piston 12, and when gas is exploded in the combustion chamber by an ignition apparatus 46 of the combustion chamber 10-1, the opening and closing plate guide rod 18-5 of the rotary assembly 8 moving along the opening and closing guide path 4-5 is moved, and the opening and closing plate 26-3 having a gas path 26-5 adapted to enhance a gas flow is opened in the exhaust chamber 30 sectioned by an exhaust chamber seal 34-4 using the opening and closing plate guide rod 16-5 as a lever and the opening and closing plate shaft pin 14-5 as an axis, and the exhaust guide rod 18-3 of the rotary assembly 8 moving along the exhaust valve guide path 4-3 opens the exhaust valve 24 using the exhaust guide rod 16-3 as a lever and the exhaust valve shaft pin 14-3 as an axis, so that the gas is expanded from the combustion chamber 10-1 to the exhaust chamber 30 for thereby rotating the rotary assembly 8, and when the gas is discharged through the exhaust port 32, the locking guide rod 18-4 of the rotary assembly 8 is moved along the locking guide path 4-4, and the locking rod 20 is moved in order to unlock the tail part shoulder 12-4 of the piston 12 using the locking guide rod 16-4 as a lever and the locking rod shaft pin 14-4 as an axis, and the suction guide rod 18-2 is moved along the suction valve guide path 4-2, and the gas is sucked into the operation chamber 10 using the suction guide rod 16-2 as a lever and the suction opening and closing valve shaft pin 14-2 as an axis, and the suction opening and closing plate 22-1 of the suction path 6-1 is moved and opened for thereby achieving a suction stroke of the piston 12, and a cooling member 42 is formed in such a manner that part of lubricant supplied from the supply path 48-1 of the rotary shaft 6 flows from the upper side of the inner wall surface of the housing to the lower side, and a scratching seal 34-3 is attached for thereby preventing a generation of pitches at an outer surface of the rotary assembly 8, and the lubricant is moved in the direction of the discharge path 48-3.

2. The engine of claim 1, wherein both ends of the suction opening and closing valve shaft pin 14-2 pass through the upper plate 8-1 and the lower plate 8-3 of the rotary assembly 8, and the suction guide rod 16-2 and the suction guide rod 18-2 are formed in vertical shapes, and the suction guide rod 18-2 is moved along the suction valve guide path 4-2 of the opposite inner surfaces of the upper plate 2-1 and the lower plate 2-3 of the housing 2, and the suction opening and closing plate 22-1 is installed at an intermediate portion between the ends of the suction opening and closing plate 22-1 for thereby opening and closing the suction path 6-1, so that the suction opening and closing valve is achieved.

3. The engine of claim 1, wherein the locking guide rod 16-4 and the locking guide rod 18-4 are vertically formed at both ends of the locking rod shaft pin 14-4 passing through the upper plate 8-1 and the lower plate 8-3 of the rotary assembly 8, and the locking guide rod 18-4 is moved along the locking guide path 4-4 formed at the inner surfaces of the upper plate 2-1 and the lower plate 2-3 of the housing 2, and the locking rod 20 engaged to the end of the locking connection rod 20-1 vertically connected with both ends of the locking rod shaft pin 14-4 locks the tail part shoulder 12-4 of the piston 12 when the front surface 12-2 and the tail part 12-3 of the piston 12 reach from the bottom dead center 40-2 of the guide member 40 to the top dead center 40-3, and the tail part 12-3 unlocks the locking rod 20 when the tail part 12-3 reaches at the height of the top dead center 4-1 with a certain distance from the guide member 40 from the take-off bottom dead center 40-4 of the guide member 40 to the landing bottom dead center 40-5 during the exhaust operation of the explosion gas.

4. The engine of claim 1, wherein a multiple-layer path support plate 26-4 capable of storing heat of exhausted gas is formed at the side of the tail part 26-2 of the opening and closing plate 26 for thereby forming a gas path 26-5, and an exhaust hole 48-2-1 is formed so that lubricant passes through the interior of the opening and closing plate 26-3 in the head part 26-1 at the side of the upper plate 801 in the direction of the head part 26-1 at the side of the lower plate 8-3 and the opening and closing guide rod 16-5.

5. The engine of claim 1, wherein at least cooling member 42 and scratching seal 34-3 are formed at the wall surface between the upper plate 2-1 and the lower plate 2-3 of the housing 2 except for the regions of the exhaust chamber seal 34-3 including the exhaust chamber 30 of the inner surface of the housing 2.
